(19) United States
(12) Patent Application Publication
(10) Pub. No.: US 2025/0244449 A1
(43) Pub. Date: Jul. 31, 2025

(54) METHODS AND APPARATUS FOR DETECTING CHARACTERISTICS OF OSCILLATIONS OF OBJECTS

(71) Applicant: Teledyne Scientific & Imaging, LLC, Thousand Oaks, CA (US)

(72) Inventors: Milind Mahajan, Thousand Oaks, CA (US); Weiya Zhang, Thousand Oaks, CA (US); John Mansell, Thousand Oaks, CA (US)

(21) Appl. No.: 19/027,324

(22) Filed: Jan. 17, 2025

Related U.S. Application Data
(60) Provisional application No. 63/625,035, filed on Jan. 25, 2024.

(51) Int. Cl. G01S 7/48

(52) U.S. Cl. CPC G01S 7/4802

(57) ABSTRACT

Methods and apparatus for detecting characteristics of oscillations of objects are provided. The method comprises emitting, by an emitter, first electromagnetic radiation towards the object. The object is oscillating at a first frequency. The method comprises receiving, by a receiver, second electromagnetic radiation reflected by the object and generating, by a controller, ranging data based on the received second electromagnetic radiation. The method comprises transforming, by the controller, the ranging data to a power spectrum, and detecting, by the controller, at least one characteristic of the oscillations of the object based on the power spectrum.

### PRIORITY

The present application claims priority under 35 U.S.C. Section 119(e) from Provisional Application 63/625,035, entitled “METHODS AND APPARATUS FOR DETECTING CHARACTERISTICS OF OSCILLATIONS OF OBJECTS”, filed on Jan. 25, 2024, the entire contents of which is incorporated herein by reference.

### FIELD OF USE

The present disclosure relates to methods and apparatus for detecting characteristics of oscillations of objects.

### BACKGROUND

The rapid development and proliferation of high speed unmanned aerial vehicles (UAVs) has increased the demand for detecting UAVs at long distances. Detecting drones and/or other undesirable objects over large distances in the presence of background clutter, such as birds, presents challenges.

### SUMMARY

One non-limiting aspect of the present disclosure is directed to a method for determining characteristics of oscillations of an object. The method comprises emitting, by an emitter, first electromagnetic radiation towards the object. The object is oscillating at a first frequency. The method comprises receiving, by a receiver, second electromagnetic radiation reflected by the object, and generating, by a controller, ranging data based on the received second electromagnetic radiation. The method comprises transforming, by the controller, the ranging data to a power spectrum, and detecting, by the controller, at least one characteristic of the oscillations of the object based on the power spectrum.

Another non-limiting aspect of the present disclosure is directed to a system for determining presence of an oscillating object. The system comprises an emitter, a receiver, and a controller. The emitter is configured to emit first electromagnetic radiation towards the object. The object is oscillating at a first frequency. The receiver is configured to receive second electromagnetic radiation reflected by the object. The controller is configured to generate ranging data based on the received second electromagnetic radiation, transform the ranging data to a power spectrum, and detect at least one characteristic of the oscillations of the object based on the power spectrum.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples presented herein, and the manner of attaining them, will become more apparent, and the examples will be better understood, by reference to the following description taken in conjunction with the accompanying drawings, wherein:

FIG. 1 is a schematic representation of a non-limiting embodiment of a system for detecting characteristics of an oscillating object according to the present disclosure;

FIG. 2 illustrates a non-limiting method for detecting characteristics of an oscillating or vibrating object according to the present disclosure;

FIG. 3 illustrates certain data received by a receiver in the time domain according to the present disclosure; and

FIG. 4 illustrates certain data from the receiver transformed into the frequency domain according to the present disclosure.

The exemplifications set out herein illustrate certain non-limiting embodiments, in one form, and such exemplifications are not to be construed as limiting the scope of the appended claims and the invention in any manner.

### DETAILED DESCRIPTION OF NON-LIMITING EMBODIMENTS

Various examples are described and illustrated herein to provide an overall understanding of the structure, function, and use of the disclosed systems, apparatus, and methods. The various examples described and illustrated herein are non-limiting and non-exhaustive. Thus, the invention is not limited by the description of the various non-limiting and non-exhaustive examples disclosed herein. Features and characteristics illustrated and/or described in connection with various examples herein may be combined with features and characteristics of other examples herein. Such modifications and variations are intended to be included within the scope of the present disclosure. The various non-limiting embodiments disclosed and described in the present disclosure can comprise, consist of, or consist essentially of the features and characteristics as variously described herein.

Any references herein to “various non-limiting embodiments”, “some non-limiting embodiments”, “certain non-limiting embodiments”, “one non-limiting embodiment”, “a non-limiting embodiment”, “an embodiment”, “one embodiment”, or like phrases mean that a particular feature, structure, act, or characteristic described in connection with the example is included in at least one embodiment. Thus, appearances of the phrases “various non-limiting embodiments”, “some non-limiting embodiments”, “certain non-limiting embodiments”, “one non-limiting embodiment”, “a non-limiting embodiment”, “an embodiment”, “one embodiment”, or like phrases in the specification do not necessarily refer to the same non-limiting embodiment. Furthermore, the particular described features, structures, or characteristics may be combined in any suitable manner in one or more non-limiting embodiments. Thus, the particular features, structures, or characteristics illustrated or described in connection with one non-limiting embodiment may be combined, in whole or in part, with the features, structures, or characteristics of one or more other non-limiting embodiments without limitation. Such modifications and variations are intended to be included within the scope of the present non-limiting embodiments.

As used herein, “at least one of” a list of elements means one of the elements or any combination of two or more of the listed elements. As an example “at least of A, B, and C” means any of A only; B only; C only; A and B; A and C; B and C; and A, B, and C.

Detecting UAVs and other target entities at long distances based on camera imagery can lead to false positives and/or false negatives as the detection may be based on only a few pixels in a camera. The same challenge applies to detection methods based on 3D shapes, where the third dimension is obtained using apparatuses like LIDARs. The present disclosure provides methods and apparatus for detecting oscillating objects, which can reduce false positives and/or false negatives and distinguish certain oscillating objects, such as UAVs, from background entities, such as birds, without shape recognitions (e.g., based on two-dimensional images or three-dimensional point clouds). For example, an embodiment of the method according to the present disclosure comprises emitting, by a laser, first electromagnetic radiation towards the object. The object is oscillating at a first frequency. The receiver receives second electromagnetic radiation reflected by the object. A controller generates ranging data based on the received second electromagnetic radiation and transforms the ranging data to a power spectrum. The controller detects at least one characteristic of the oscillations of the object based on the power spectrum. A conventional apparatus for detecting vibration or oscillation, such as a laser Doppler vibrometer, have limitations on the standoff distance due to constraints including the laser's coherent length. For example, a laser Doppler vibrometer's stand off range is less than a few hundreds of meters, and is typically a few meters to a few tens of meters.

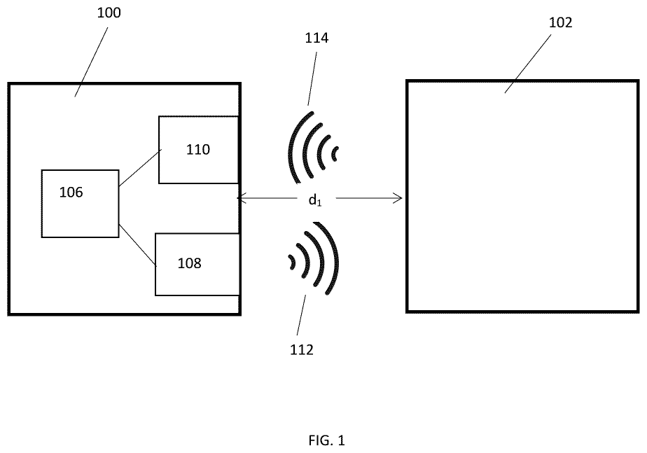

FIG. 1 illustrates a non-limiting embodiment of a system 100 for detecting an oscillating object 102 according to the present disclosure. The system 100 can comprise an emitter 108, a receiver 110 (e.g., a detector), and a controller 106. The system 100 can be configured to distinguish the oscillating or vibrating object 102 from a background entity, such as, for example, a bird, a kite, or a balloon.

The object 102 to be detected can comprise various types of continuously or intermittently oscillating objects. In various non-limiting embodiments, the object 102 can comprise a motor or other device that causes the object to measurably oscillate as a result of motor rotation. In various non-limiting embodiments, the motor can comprise a mechanical engine and the engine can perform a repetitive motion. For example, the object 102 can comprise a manned vehicle, a UAV, a generator, other oscillating object, or a combination thereof. In various non-limiting embodiments, the object 102 is a UAV. The object 102 oscillates at an oscillation frequency, f₂. In certain non-limiting embodiments, the oscillation frequency, f₂, can correspond to a rotational or other speed of a motor within the object 102. In various non-limiting embodiments, the oscillation frequency, f₂, can be in a range of 1 Hertz (Hz) to 5 kHz, such as, for example, 2 Hz to 300 Hz (e.g., drones and cars). In various non-limiting embodiments in which the object 102 is a manned vehicle, such as, for example, a car, the car can comprise an oscillation frequency of 8 Hz while idling and an oscillation frequency of 30 Hz while being driven on a highway. In certain non-limiting embodiments in which the object 102 is a UAV, the UAV can comprise an oscillation frequency in a range of 2 Hz to 30 Hz while in flight. In various non-limiting embodiments, the object 102 can oscillate at multiple frequencies, which may be a result of multiple oscillating devices within the object (e.g., multiple motors), multiple frequencies related to the oscillation of the object, harmonics of the oscillation frequency, f₂, or a combination thereof.

In various non-limiting embodiments, the object 102 can be difficult to visually distinguish from the background and/or other entities. For example, the object 102 may be in a field of view comprising clutter, may be camouflaged, or a combination thereof. The clutter can comprise a bird, a tree, a forest of trees, other similar background entities, or a combination thereof. In various non-limiting embodiments, the object 102 may comprise an unmanned aerial vehicle and the clutter can comprise a bird.

The emitter 108 can comprise a laser and optical transmission elements, and can be configured to emit electromagnetic radiation 112 towards the object 102. In various non-limiting embodiments, the emitter 108 can be configured to emit pulses of electromagnetic radiation 112 towards the object 102, as shown in FIG. 1. Although the electromagnetic radiation 112 is described as pulses herein, the electromagnetic radiation also can take other forms of amplitude and/or phase modulation. For example, the emitter 108 can emit electromagnetic radiation 112 through a process of optical amplification based on the stimulated emission of electromagnetic radiation. For example, the emitter 108 may be a laser. The emitted electromagnetic radiation may not substantially spread or diffuse. In various non-limiting embodiments, the laser can be a pulsed laser. In certain non-limiting embodiments, the emitter 108 can comprise a laser diode, a flashlamp laser, an ion laser, an electrical discharge laser, an excimer laser, or a combination thereof. In various embodiments, the wavelength of the electromagnetic radiation 112 emitted by the emitter 108 can be in a range of 300 nm to 2000 nm, such as, for example, 700 nm to 2000 nm, 800 nm to 2000 nm, or 800 nm to 1600 nm. For example, in certain embodiments the wavelength of the electromagnetic radiation 112 emitted by the emitter 108 can be 905 nm or 1550 nm.

In various non-limiting embodiments, the emitter 108 emits a pulse of electromagnetic radiation 112. The emitter 108 may emit pulses of electromagnetic radiation at a pulse rate frequency, f₁. The pulse rate frequency, f₁, can be different than the oscillation frequency, f₂, of the object 102. As used herein, “pulse rate frequency” refers to the frequency at which a laser pulse is switched on and off, and does not refer to the frequency of a wavelength of electromagnetic radiation. Pulse rate frequency, f₁, is the frequency at which the device takes samples in the measurement and may be at least twice the highest frequency component of the oscillation characteristics according to Nyquist's theorem. For example, the pulse rate frequency, f₁, can be at least twice the oscillation frequency, f₂, of the object 102, such as, for example, at least 2.5 times or at least 3 times the oscillation frequency, f₂, of the object 102. Providing a pulse rate frequency, f₁, greater than the oscillation frequency, f₂, of the object 102 can enable detection of the object 102.

The receiver 110 can be configured to receive electromagnetic radiation 114 reflected or scattered by the object 102, such as, for example, pulses of electromagnetic radiation 114. For example, the electromagnetic radiation 114 emitted towards the object 102 can be at least partially reflected by the object 102 back towards the receiver 110 as electromagnetic radiation 114. The receiver 110 can receive the pulses of electromagnetic radiation 114 and determine a signal therefrom. For example, the receiver 110 can be configured to receive intensity of the electromagnetic radiation 114 over time. In certain embodiments, the receiver 110 can comprise the optical receiving elements and optical receiver. For example, the receiver may be a photodiode, avalanche photodiode (APD), single-photon avalanche photodiode (SPAD), silicon photomultiplier (SiPM), photomultiplier tube (PMT), a CCD sensor, a CMOS sensor, a SPAD array, other sensor capable of detecting electromagnetic radiation, or a combination thereof.

The controller 106 can be in signal communication with the emitter 108 and the receiver 110. For example, the controller 106 can be hardwired to and/or in wireless communication with the emitter 108 and the receiver 110. As used herein, the term “controller” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or FPGA), state machine circuitry, firmware that stores instructions executed by programmable circuitry, and any combination thereof. The controller may, be embodied, collectively or individually, as circuitry that forms part of a larger system, for example, an IC, an ASIC, a SoC, desktop computer(s), laptop computer(s), tablet computer(s), server(s), smart phone(s), etc. Accordingly, as used herein, a “controller” can comprise electrical circuitry having at least one discrete electrical circuit, electrical circuitry having at least one IC, electrical circuitry having at least one application-specific IC, electrical circuitry forming a general-purpose computing device configured by a computer program (e.g., a general-purpose computer configured by a computer program that at least partially carries out processes and/or devices described herein or a microprocessor configured by a computer program that at least partially carries out processes and/or devices described herein), electrical circuitry forming a memory device (e.g., forms of RAM), and/or electrical circuitry forming a communications device (e.g., a modem, communications switch, or optical-electrical equipment). The subject matter described herein may be implemented in an analog or digital fashion, or some combination thereof.

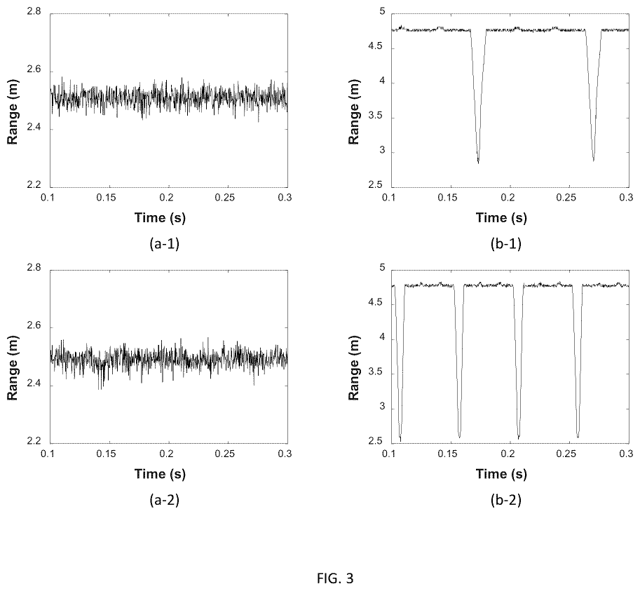

The controller 106 can be configured to perform a spectral analysis of the detected electromagnetic radiation received by the receiver 110. For example, in certain embodiments the controller 106 can be configured to generate ranging data, as illustrated in FIG. 3. The controller 106 can generate the ranging data based on the received electromagnetic radiation 114. In various non-limiting embodiments, the controller can process the received intensity of electromagnetic radiation 114 as a function of time to determine the ranging data.

In various non-limiting embodiments, the controller 106 can determine, over a period of time, a time of flight for the electromagnetic radiation from the emitter 108 to the receiver 110. The time of flight of the electromagnetic radiation is the time period during which the electromagnetic radiation initially is emitted by the emitter 108, travels to and is reflected back from the object 102, and finally is received by the receiver 110. As the speed of the electromagnetic radiation 112 is known, the time of flight from the emitter 108 and back to the receiver 110 can be used to calculate a distance, di, of the object 102 from the receiver 110.

The ranging data generated by the controller 106 may comprise a time series of the ranging results and show how the measured range of the object 102 changes over time.

In certain non-limiting embodiments in which the object 102 is a UAV, a motor of the UAV can drive a propeller of the UAV to enable movement of the UAV through the air, and the motor may produce oscillations of the UAV itself (e.g., vibrations). The oscillations create a periodic movement of the UAV that may or may not be associated with the general movement of the UAV. Constant movement of the UAV would be associated with a constant non-periodic change in the time of flight determined by the controller 103 and/or minor constant changes would be associated with a periodic change in the time of flight below a minor threshold frequency (e.g., less than 1 Hertz). In contrast to the general movement of the UAV, the oscillation of the UAV results in periodic change in the time of flight of the detected electromagnetic radiation associated with the object 102.

The controller 106 can be configured to transform the ranging data to a power spectrum. For example, the ranging data can be converted, by the controller 106, from the time domain to the frequency domain to obtain the power spectrum. In various non-limiting embodiments, the controller 106 can use a Fourier transform (e.g., Fast Fourier Transform) to convert the ranging data to the power spectrum. The power spectrum can comprise a number of discrete frequencies over a continuous range. In various non-limiting embodiments, the power spectrum comprises characteristic spectral lines of the oscillations of the object 102. The spectral lines can comprise a frequency and an amplitude. The spectral signal can be observed even if the amplitude of the oscillation or vibration is smaller than the distance resolution based on a single time of flight measurement.

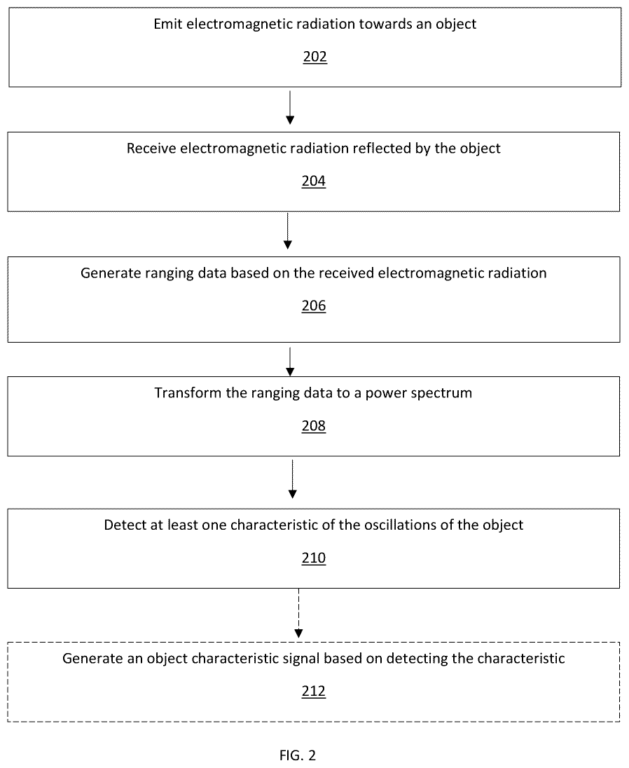

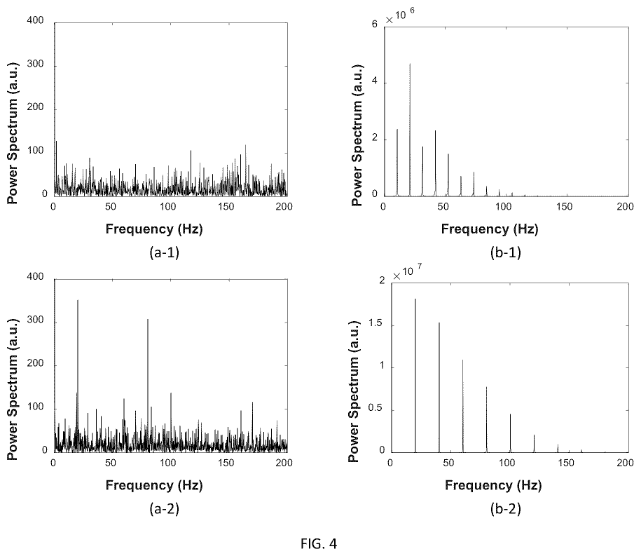

For example, in certain embodiments the controller can transform ranging data, as shown in FIG. 3, to a power spectrum, as illustrated in FIG. 4. FIG. 3(a-1) illustrates ranging data versus time where the emitter 108 is aimed at the arm of the UAV and the UAV is still. FIG. 4(a-1) illustrates the power spectrum for the ranging data of FIG. 3(a-1). FIG. 3(a-2) illustrates ranging data versus time where the emitter 108 is aimed at the arm of the UAV and the UAV is at 18% thrust. FIG. 4(a-2) illustrates the power spectrum for the ranging data of FIG. 3(a-2). FIG. 3(b-1) illustrates ranging data versus time where the emitter 108 is aimed at the propeller of the UAV and the UAV is at 9% thrust. FIG. 4(b-1) illustrates the power spectrum for the ranging data of FIG. 3(b-1). FIG. 3(b-2) illustrates ranging data versus time where the emitter 108 is aimed at the propeller of the UAV and the UAV is at 18% thrust. FIG. 4(b-2) illustrates the power spectrum for the ranging data of FIG. 3(b-2).

Referring back to FIG. 1, the controller 106 can be configured to detect at least one characteristic of the oscillations of the object 102 based on the power spectrum. For example, the controller may determine a frequency, f₃, in the power spectrum comprising an amplitude equal to or greater than a pre-determined threshold amplitude. The predetermined threshold amplitude can be set to an amplitude greater than background noise, such as, for example, at least 3 dB. When the amplitude is greater than or equal to the threshold amplitude, the controller 106 determines that an oscillating object 102 has been detected. Amplitudes of at least the predetermined threshold amplitude and at frequencies higher than a certain de minimis frequency (e.g., equal to or greater than 1 Hz) can relate to the oscillations of the object 102. In various non-limiting embodiments, the frequency, f₃, is the same as the frequency, f₂, or the frequency, f₃, is a harmonic of the oscillations of the object 102. For example, the controller may also use adaptive algorithms to detect spectral peak in the power spectrum. For instance, in a cell-averaging constant false alarm rate (CA-CFAR) detection, the threshold level is calculated by estimating the noise floor level around the frequency line under test. In this case, the threshold level is raised and lowered to maintain a constant probability of false alarm.

The object frequency, f₃, can be the same as the oscillation frequency, f₂, of the object 102. Because the object 102 was determined to be oscillating at a frequency equal to or greater than a predetermined threshold, the object 102 can be differentiated from background entities and can be considered an object of interest. The object frequency, f₃, can be a characteristic of the object 102, and the controller 106 can further classify the object 102 based on the characteristic of the object frequency, f₃. The characteristic of the object 102 can include an amplitude of a spectral line, a frequency of a spectral line, multiple spectral lines, a relationship between spectral lines, other characteristics of a power spectrum, or a combination thereof. In various non-limiting embodiments, the object 102 can be identified by the controller based on the power spectrum.

For example, the object 102 can be distinguished from clutter based on the power spectrum. The detected characteristic of the oscillations of the object can be used to distinguish the object 102 from clutter, identify a camouflaged object, or a combination thereof. For example, the identification of a spectral line having a frequency, amplitude, or a combination thereof above a threshold may be used to determine presence of the object 102.

In various non-limiting embodiments, the controller 106 can determine an operating status of the object 102 by comparing the determined at least one characteristic of the oscillations of the object 102 to at least one previously determined characteristic. The previously determined characteristic can be a characteristic detected previously, a manually entered characteristics, a characteristic from a database, or a combination thereof. In various non-limiting embodiments, the operating status determined can be machine health, battle damage assessment, or a combination thereof.

In certain embodiments where the object 102 comprises a motor, the motor may typically operate with oscillations that produce a first characteristic, and determining a deviation from the first characteristic based on a comparison to a previous characteristic can be used to determine that the motor is operating in a state different than the compared state (e.g., running faster, running slower, off, or on).

In certain embodiments, detecting a deviation (change) in a detected characteristic relative to a previous characteristic can be used to identify a vehicle, device, or other object that has been damaged (e.g., absence of a characteristic may mean the vehicle, device, or other object is no longer operating).

Referring again to FIG. 1, the controller 106 may be configured to generate an object characteristic signal based on detecting the characteristic of oscillations of the object 102. The object presence signal can be sent to a display, an alarm, and/or other device to indicate that an oscillating object 102 has been detected, health of the object 102, battle damage assessment of the object 102, or a combination thereof.

In various non-limiting embodiments, the system 100 can be a simple standalone system as shown in FIG. 1, or be integrated into a larger system with various components. In certain non-limiting embodiments, the system 100 can comprise LIDAR, a laser range finder, or a combination thereof. In various non-limiting embodiments, the system 100 is integrated into a gimbal, a helicopter, a plane, a manned vehicle, an unmanned aerial vehicle, or a combination thereof.

The system 100 can work on detecting objects 102 at short range (e.g., where di is no greater than 100 m) or at long ranges (e.g., where di is greater than 1 km). For example, di can be in a range of 0.1 m to 10 km, 1 m to 5 km, or 10 m to 2 km. The system 100 can be used beyond a detection system's limit for accurate measurement of displacement, velocity, and/or distance, as the system 100 can use the intrinsic periodic nature of the oscillation frequency, f₂, as opposed to an absolute value accuracy.

FIG. 2 illustrates a non-limiting of a method for determining presence of an oscillating object according to the present disclosure. The method can be performed using, for example, the system 100 as described with respect to FIG. 1. As illustrated, at step 202, the method 200 comprises emitting electromagnetic radiation 112 towards the object 102 from the emitter 108. The electromagnetic radiation 112 can travel the distance, di, towards the object 102 and contact the object 102. The object 102 can reflect at least a portion of the electromagnetic radiation 112 back towards the receiver 110 as electromagnetic radiation 114.

At step 204, the method 200 comprises receiving electromagnetic radiation 114 reflected by the object 102.

At step 206, the method 200 comprises generating ranging data based on the received electromagnetic radiation. In various non-limiting examples, generating ranging data may comprise determining a time of flight for the reflected pulses of the electromagnetic radiation detected by the receiver 110. For example, the controller 106 can generate the ranging data by determining, over a period of time, a time of flight for the pulses of electromagnetic radiation 114 from the emitter 108 to the receiver 110.

At step 208, the ranging data can be transformed to a power spectrum by the controller 106.

At step 210, a characteristic of the oscillations of the object 102 can be detected by the controller 106. For example, the detecting the characteristics can comprise determining an object frequency in the power spectrum comprising an amplitude equal to or greater than a pre-determined threshold amplitude.

At step 212, an object presence signal can optionally be generated based on the detected presence of the object 102 by the controller 106.

Embodiments of a method according to the present disclosure can be implemented with LIDAR, a laser range finder, other equipment, or a combination thereof, and may not require additional standalone hardware, although the method can include additional standalone hardware if desired. Embodiment of the method can add additional functionality to existing detection devices without adding additional hardware, which is beneficial in optimizing the size, weight, power, and cost of the integrated system.

Embodiments disclosed herein may be embodied as a system, method, or computer program product. Accordingly, embodiments according to the present disclosure may take the form of an entirely hardware embodiment, an entirely software embodiment (including firmware, resident software, micro-code, etc.), or an embodiment including software and hardware aspects that may all generally be referred to herein as a “circuit,” “module,” or “system”. Furthermore, embodiments according to the present disclosure may take the form of a computer program product embodied in one or more computer readable medium having computer readable program code embodied thereon.

Various aspects of non-limiting embodiments of an invention according to the present disclosure include, but are not limited to, the aspects listed in the following numbered clauses.

Clause 1. A method for determining characteristics of oscillations of an object, the method comprising: emitting, by an emitter, first electromagnetic radiation towards the object, wherein the object is oscillating at a first frequency; receiving, by a receiver, second electromagnetic radiation reflected by the object; generating, by a controller, ranging data based on the received second electromagnetic radiation; transforming, by the controller, the ranging data to a power spectrum; and detecting, by the controller, at least one characteristic of the oscillations of the object based on the power spectrum.

Clause 2. The method of clause 1, further comprising generating, by the controller, an object characteristic signal based on detecting the characteristic.

Clause 3. The method of any of clauses 1-2, wherein transforming, by the controller, the ranging data to the power spectrum comprises using a Fourier transform.

Clause 4. The method of any of clauses 1-3, wherein generating, by the controller, the ranging data comprises determining, over a period of time, a time of flight for the electromagnetic radiation from the emitter to the receiver.

Clause 5. The method of any of clauses 1-4, wherein transforming, by the controller, comprises determining a second frequency in the power spectrum comprising an amplitude equal to or greater than a threshold amplitude.

Clause 6. The method of clause 5, wherein the second frequency is the same as the first frequency or a harmonic of the oscillations of the object.

Clause 7. The method of any of clauses 1-6, wherein the ranging data comprises data matching times of flight and amplitudes of those times of flight, and wherein the power spectrum comprises data matching frequencies and amplitudes of those frequencies.

Clause 8. The method of any of clauses 1-7, wherein the object comprises a motor.

Clause 9. The method of any of clauses 1-8, wherein the object comprises a manned vehicle, an unmanned aerial vehicle, a generator, or a combination thereof.

Clause 10. The method of any of clauses 1-9, wherein the first frequency is in a range of 1 Hertz (Hz) to 5 kHz.

Clause 11. The method of any of clauses 1-10, wherein the emitter comprises a pulsed laser, the first electromagnetic radiation is emitted in first pulses of electromagnetic radiation at a second frequency, and the second frequency is at least twice the first frequency.

Clause 12. The method of any of clauses 1-11, wherein the characteristic includes an amplitude of a spectral line, a frequency of a spectral line, multiple spectral lines, a relationship between spectral lines, other characteristics of the power spectrum, or a combination thereof.

Clause 13. The method of any of clauses 1-12, wherein the object is in a field of view comprising clutter, the object is camouflaged, or a combination thereof.

Clause 14. The method of clause 13, wherein the object is an unmanned aerial vehicle and the clutter comprises a bird.

Clause 15. The method of any of clauses 1-14, further comprising determining an operating status of the object by comparing the detected at least one characteristic to at least one previously determined characteristic.

Clause 16. A system for determining presence of an oscillating object, the system comprising: an emitter configured to emit first electromagnetic radiation towards the object, wherein the object is oscillating at a first frequency; a receiver configured to receive second electromagnetic radiation reflected by the object; and a controller configured to: generate ranging data based on the received second electromagnetic radiation; transform the ranging data to a power spectrum; and detect at least one characteristic of the oscillations of the object based on the power spectrum.

Clause 17. The system of clause 16, wherein the system comprises a LIDAR, a laser range finder, or a combination thereof.

Clause 18. The system of any of clauses 16-17, wherein the controller is further configured to generate an object characteristic signal based on detecting the at least one characteristic.

Clause 19. The system of any of clauses 16-18, wherein the first frequency is in a range of 1 Hertz (Hz) to 5 kHz.

Clause 20. The system of any of clauses 16-19, wherein the object comprises a manned vehicle, an unmanned aerial vehicle, a generator, or a combination thereof.

Clause 21. The system of any of clauses 16-20, wherein the system comprises a gimbal, a helicopter, a plane, a manned vehicle, an unmanned aerial vehicle, or a combination thereof.

In the present disclosure, unless otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in the present disclosure is intended to include all higher numerical limitations subsumed therein. Accordingly, Applicant reserves the right to amend the present disclosure, including the claims, to expressly recite any sub-range subsumed within the ranges expressly recited. All such ranges are inherently described in the present disclosure.

The grammatical articles “a”, “an”, and “the”, as used herein, are intended to include “at least one” or “one or more”, unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

One skilled in the art will recognize that the herein described apparatus, systems, structures, methods, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A method for determining characteristics of oscillations of an object, the method comprising:
emitting, by an emitter, first electromagnetic radiation towards the object, wherein the object is oscillating at a first frequency;
receiving, by a receiver, second electromagnetic radiation reflected by the object;
generating, by a controller, ranging data based on the received second electromagnetic radiation;
transforming, by the controller, the ranging data to a power spectrum; and
detecting, by the controller, at least one characteristic of the oscillations of the object based on the power spectrum.

2. The method of claim 1, further comprising generating, by the controller, an object characteristic signal based on detecting the characteristic.

3. The method of claim 1, wherein transforming, by the controller, the ranging data to the power spectrum comprises using a Fourier transform.

4. The method of claim 1, wherein generating, by the controller, the ranging data comprising determining, over a period of time, a time of flight for the electromagnetic radiation from the emitter to the receiver.

5. The method of claim 1, wherein transforming, by the controller, comprises determining a second frequency in the power spectrum comprising an amplitude equal to or greater than a threshold amplitude.

6. The method of claim 5, wherein the second frequency is the same as the first frequency or a harmonic of the oscillations of the object.

7. The method of claim 1, wherein the object comprises a motor.

8. The method of claim 1, wherein the object comprises a manned vehicle, an unmanned aerial vehicle, a generator, or a combination thereof.

9. The method of claim 1, wherein the first frequency is in a range of 1 Hertz (Hz) to 5 KHz.

10. The method of claim 1, wherein the emitter comprises a pulsed laser, the first electromagnetic radiation is emitted in first pulses of electromagnetic radiation at a second frequency, and the second frequency is at least twice the first frequency.

11. The method of claim 1, wherein the characteristic includes an amplitude of a spectral line, a frequency of a spectral line, multiple spectral lines, a relationship between spectral lines, other characteristics of the power spectrum, or a combination thereof.

12. The method of claim 1, wherein the object is in a field of view comprising clutter, the object is camouflaged, or a combination thereof.

13. The method of claim 12, wherein the object is an unmanned aerial vehicle and the clutter comprises a bird.

14. The method of claim 1, further comprising determining an operating status of the object by comparing the determined at least one characteristic to at least one previously determined characteristic.

15. A system for determining presence of an oscillating object, the system comprising:
an emitter configured to emit first electromagnetic radiation towards the object, wherein the object is oscillating at a first frequency;
a receiver configured to receive second electromagnetic radiation reflected by the object; and
a controller configured to:
generate ranging data based on the received second electromagnetic radiation;
transform the ranging data to a power spectrum; and
detect at least one characteristic of the oscillations of the object based on the power spectrum.

16. The system of claim 15, wherein the system comprises a LIDAR, a laser range finder, or a combination thereof.

17. The system of claim 15, wherein the controller is further configured to generate an object characteristic signal based on detecting the at least one characteristic.

18. The system of claim 15, wherein the first frequency is in a range of 1 Hertz (Hz) to 5 kHz.

19. The system of claim 15, wherein the object comprises a manned vehicle, an unmanned aerial vehicle, a generator, or a combination thereof.

20. The system of claim 15, wherein the system comprises a gimbal, a helicopter, a plane, a manned vehicle, an unmanned aerial vehicle, or a combination thereof.
